(19) United States
(12) Patent Application Publication
(10) Pub. No.: US 2024/0020746 A1
(43) Pub. Date: Jan. 18, 2024

(54) INFORMATION MANAGEMENT DEVICE, INFORMATION MANAGEMENT SYSTEM, AND METHOD FOR MANAGING COMMODITY INFORMATION

(71) Applicant: Toshiba Tec Kabushiki Kaisha, Tokyo (JP)

(72) Inventor: Takashi SUGIMOTO, Mishima Shizuoka (JP)

(21) Appl. No.: 18/317,860

(22) Filed: May 15, 2023

(30) Foreign Application Priority Data
Jul. 12, 2022 (JP) 2022-111501

(51) Int. Cl. G06Q 30/0601; G06Q 10/1093

(52) U.S. Cl. CPC G06Q 30/0631; G06Q 10/1095; G06Q 30/0639

(57) ABSTRACT

An information management device for managing commodity information of commodities sold at stores, includes a communication interface configured to communicate with a user terminal in which a scheduled event can be registered, a memory that stores setting information in which one or more commodity types are associated with an event that can be registered by the user terminal and commodity information of commodities that are of the one or more commodity types, and a processor configured to: acquire event information indicating a first event registered by the user terminal via the communication interface, based on the event information, search the memory for one or more of the commodity types associated with the first event, acquire commodity information of each of the commodities of the one or more commodity types, and control the communication interface to transmit the commodity information to the user terminal.

### CROSS-REFERENCE TO RELATED APPLICATION(S)

This application is based upon and claims the benefit of priority from Japanese Patent Application No. 2022-111501, filed Jul. 12, 2022, the entire contents of which are incorporated herein by reference.

### FIELD

Embodiments described herein relate generally to an information management device, an information management system, and a method for managing commodity information of commodities sold at stores.

### BACKGROUND

Conventionally, information processing devices, such as smart phones and personal computers (PCs), have a function of managing the schedules of the users. The user can register his or her own schedule by manually entering the schedule in the schedule table stored in the device (hereinafter, also referred to as “user terminal”).

In a conventional user terminal, when an event is registered in the schedule table, information related to the event is automatically retrieved from a social media website and registered in the schedule table. Although this function can improve the convenience of the user, it may not be sufficient for some users who want their user terminals to utilize the registered schedules more actively.

On the other hand, stores that sell commodities and provide services to consumers and businesses that conduct online sales, etc. (hereinafter also collectively referred to as “store”) provide information about the commodities or services to the consumers in their sales promotion activities. However, providing the consumers with such information for the convenience of the store may not be sufficient to draw the consumers' attention to the promoted commodity or service.

### SUMMARY OF THE INVENTION

Embodiments of the present invention provide an information processing apparatus and a commodity information providing system capable of contributing to an improvement in sales of a store selling a commodity by utilizing a schedule of a user registered in a user terminal.

An information management device for managing commodity information of commodities sold at stores, comprises a communication interface configured to communicate with a user terminal in which a scheduled event can be registered, a memory that stores setting information in which one or more commodity types are associated with an event that can be registered by the user terminal and commodity information of commodities that are of the one or more commodity types, and a processor. The processor is configured to: acquire event information indicating a first event registered by the user terminal via the communication interface, based on the event information, search the memory for one or more of the commodity types associated with the first event, acquire commodity information of each of the commodities of the one or more commodity types, and control the communication interface to transmit the commodity information to the user terminal.

### BRIEF DESCRIPTION OF THE DRAWINGS

FIG. 1 is a schematic diagram of a commodity information providing system according to an embodiment.

FIG. 2 is a hardware block diagram of a user terminal according to an embodiment.

FIG. 3 depicts a data structure of an event file stored in the user terminal.

FIG. 4 depicts a data structure of a schedule management file stored in the user terminal.

FIG. 5 is a functional block diagram of the user terminal.

FIG. 6 is a hardware block diagram of a server device according to an embodiment.

FIG. 7 depicts a data structure of a user master file stored in the server device.

FIG. 8 depicts a data structure of a commodity information management file stored in the server device.

FIG. 9 depicts a data structure of a commodity setting file stored in the server device.

FIG. 10 depicts a data structure of a transmission timing setting file stored in the server device.

FIG. 11 depicts a data structure of a transmission information management file stored in the server device.

FIG. 12 is a functional block diagram of the server device.

FIG. 13 is a sequence chart of an operation of the commodity information providing system.

FIG. 14 is a flowchart of a transmission timing setting process performed by the server device.

FIG. 15 is a flowchart of a commodity information transmission process performed by the server device.

FIG. 16 depicts a first display screen displayed on the user terminal.

FIG. 17 depicts a second display screen displayed on the user terminal.

FIG. 18 depicts a third display screen displayed on the user terminal.

FIG. 19 depicts a fourth display screen displayed on the user terminal.

FIG. 20 depicts a fifth display screen displayed on the user terminal.

### DETAILED DESCRIPTION

Hereinafter, embodiments will be described in detail with reference to the drawings. The present invention is not limited to the embodiments described below.

For example, in the embodiments described below, a server device manages commodity information of commodities sold by a plurality of stores, but the present invention is not limited thereto. A store server or the like operated by each store may manage the commodity information instead.

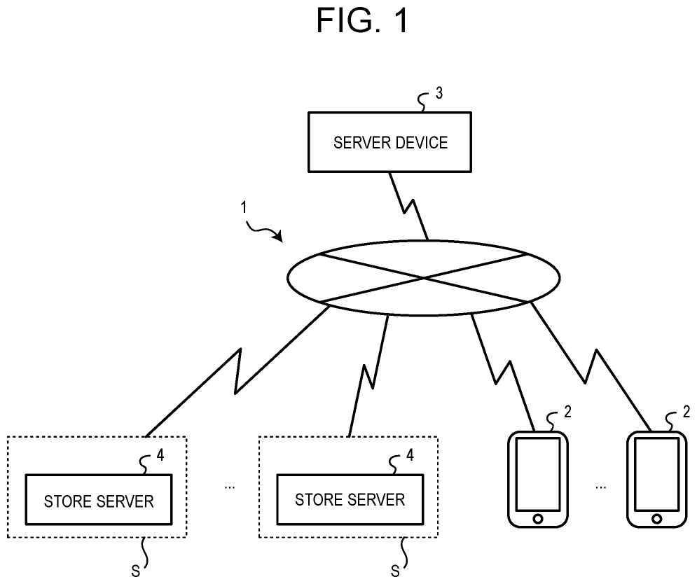

FIG. 1 is a schematic diagram of a commodity information providing system 1 according to an embodiment. The commodity information providing system 1 provides its service for a plurality of stores S and a plurality of consumers (hereinafter, also referred to as “users”). The commodity information providing system 1 includes one or more user terminals 2, a server device 3, and one or more store servers 4. The user terminals 2, the server device 3, and the store servers 4 are communicably connected to each other via a network such as the Internet. The number of the user terminals 2, the store servers 4, and the stores S is not limited to the illustrated example. The server device 3 can be constituted by two or more server devices.

The user terminal 2 is a terminal device such as a smartphone owned by a user of the commodity information providing system 1. The user terminal 2 has a function of registering and managing the schedule of the user. The user terminal 2 transmits event information indicating an event registered as a schedule to the server device 3. The event information includes the description of the event and the date on which the event is scheduled.

In addition, the user terminal 2 receives commodity information of a commodity related to the event from the server device 3. It is desirable that the commodity information includes a commodity type, a commodity name, store information of the store S that sells the commodity, and the like. The user terminal 2 displays the received commodity information. Thus, the user can recognize the commodity to be prepared for the scheduled event by browsing the commodity information displayed on the user terminal 2.

The server device 3 is an information management device that manages user information acquired from a user. Further, the server device 3 manages commodity information acquired from each store S. The server device 3 receives event information from the user terminal 2 and determines commodity information related to the event information. For example, when the description of the event based on the received event information indicates “trip”, the server device 3 determines commodity information of commodities, such as “suitcase”, “bag”, “hat”, and “lunch box”, from the commodity information to be managed.

The server device 3 sets a timing at which the commodity information is transmitted to the user terminal 2. The timing at which the commodity information is transmitted is set based on the date (hereinafter, also referred to as “scheduled event date”) on which the event included in the event information is scheduled.

In the present embodiment, the server device 3 sets a timing at which the commodity information is transmitted to the user terminal 2 in accordance with the commodity information. Specifically, for commodity information of a commodity that is desired to be prepared before the scheduled event, the transmission timing is set at a timing relatively earlier than the scheduled event date. For example, when the event is “trip”, the transmission timing of the commodity information of commodities, such as “suitcase”, “bag”, and “hat”, which are non-food commodities, is set about one month prior to the scheduled date of the event.

When the event is “trip”, the transmission timing of the commodity information of a commodity such as “lunch” or “food for lunch”, which is a food commodity is set immediately before the scheduled date of the event, for example, from one day to about one week. This is because it is assumed that the food commodity is prepared immediately before the event, and therefore there is a possibility that the user will forget the commodity information if it is sent too early. In particular, the content of the “lunch” or the like may change depending on the time of the store S, and there is a possibility that the commodity information transmitted at an early stage is no longer useful around the day of the event.

Note that the transmission timing of the commodity information may be set at the same timing regardless of the commodity information. The server device 3 transmits the commodity information to the user terminal 2 at the set timing.

The store server 4 is installed in each store S. The store server 4 transmits the commodity information of the commodity sold at the store S to the server device 3. When there is a change in the commodity sold at the store S, the store server 4 appropriately transmits the commodity information to the server device 3.

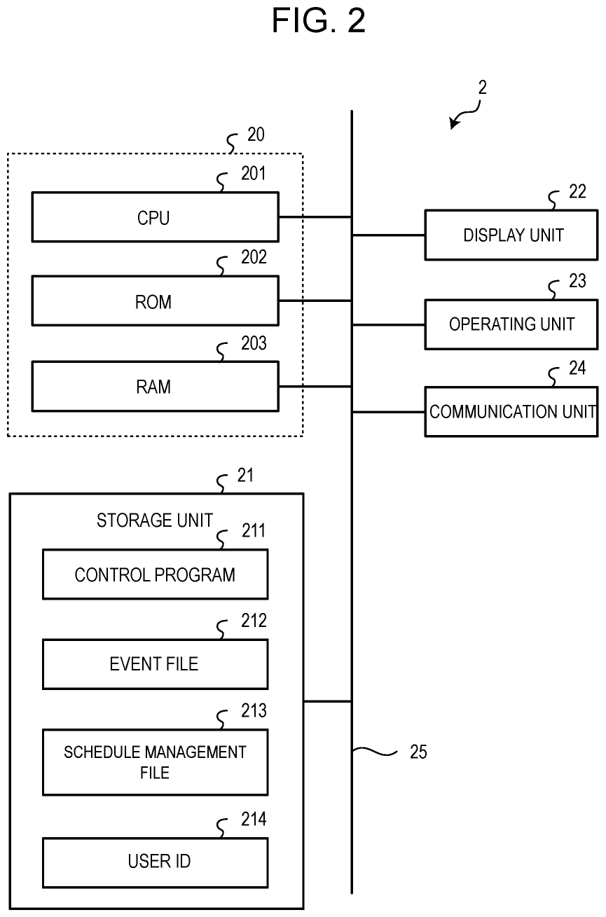

Next, the user terminal 2 will be described in detail. FIG. 2 is a hardware block diagram of the user terminal 2. The user terminal 2 includes a control unit 20, a storage unit 21, a display unit 22, an operating unit 23, and a communication unit 24. The control unit 20, the storage unit 21, the display unit 22, the operating unit 23, and the communication unit 24 are connected to each other via a bus 25 or the like.

The control unit 20 is a controller including a Central Processing Unit 201 (CPU) and a Read Only Memory (ROM) 202, a Random Access Memory (RAM) 203. The CPU 201, the ROM 202 and the RAM 203 are connected to each other via the bus 25.

The CPU 201 controls the entire operation of the user terminal 2. The ROM 202 stores various programs such as programs executed by the CPU 201 and various types of data. The RAM 203 is used as a work area of the CPU 201 and temporarily stores various programs and various data loaded from the ROM 202 and the storage unit 21. The control unit 20 or the CPU 201 executes various control processes of the user terminal 2 in accordance with a control program stored in the ROM 202 or the storage unit 21 and loaded onto the RAM 203.

The storage unit 21 is constituted by a storage medium such as a Hard Disk Drive (HDD) or a flash memory, and maintains the stored content even if the power supply is cut off. The storage unit 21 stores a control program 211, an event file 212, a schedule management file 213, and a user ID 214.

The control program 211 realizes a function of registering and managing the schedule of the user, a function of transmitting information about the scheduled event to the server device 3, a function of displaying commodity information received from the server device 3, and the like.

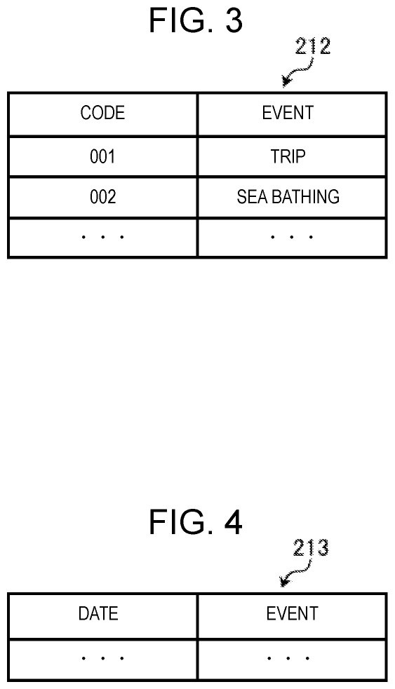

The event file 212 is a file in which an event input as a schedule is set. FIG. 3 depicts a data structure of the event file 212. The event file 212 stores codes and events in association with each other. Thus, when a code is input through the operating unit 23, the control unit 20 can determine the input event. The event file 212 may be updated based on information from the server device 3.

The code is information for specifying an event. The event is information indicating the description of the event registered in the schedule of the user. As the event, for example, various events such as “trip”, “homecoming”, “sports”, “festival”, “camp”, “examination”, “doctor appointment”, and “wedding” are assumed.

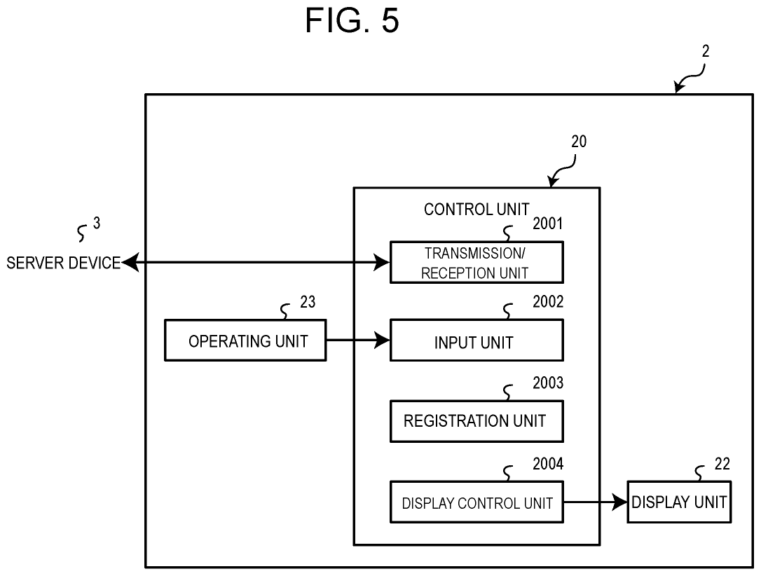

The schedule management file 213 manages event information, that is, information in which the description of the input event and the scheduled event date are associated with each other as a schedule. FIG. 4 depicts a data structure of the schedule management file 213. That is, the schedule management file 213 stores the date and the event in association with each other.

The date is information indicating the date on which the event is scheduled, that is, the scheduled event date. The event is information indicating the description of the event. When the user operates the operating unit 23 to input the code of the event and the scheduled date of the event, the date and information related to the event are registered in the schedule management file 213.

The user ID is identification information for identifying a user. The user ID is transmitted from the server device 3 to the user terminal 2, for example, when the user registers the user information in the server device 3. The user ID is transmitted in association with some information when the user terminal 2 transmits the information to the server device 3.

Referring back to FIG. 2, the hardware configuration of the user terminal 2 will be described.

The display unit 22 is a display device and includes a liquid crystal display or the like. The display unit 22 displays various types of information under the control of the control unit 20. For example, the display unit 22 displays an operation screen for inputting an event code and an event scheduled date. Further, the display unit 22 displays the commodity information received from the server device 3.

The operating unit 23 is an input device and includes a touch panel or the like provided on the surface of the display unit 22. The operating unit 23 is used for the user to input various kinds of information by the user's operation. For example, the operating unit 23 receives an input of an event code and an event scheduled date.

The communication unit 24 is a communication interface circuit for communicating with an external device such as the server device 3. The control unit is connected to an external device via the communication unit 24, so that information or data can be transmitted and received to and from the external device.

Next, a functional configuration of the control unit 20 of the user terminal 2 will be described. FIG. 5 is a functional block diagram of the control unit of the user terminal 2. The control unit 20 functions as a transmission/reception unit 2001, an input unit 2002, a registration unit 2003, and a display control unit 2004 when the CPU 201 executes the control program stored in the ROM 202 or the storage unit 21. Note that one or more of these functions may be performed by hardware such as a dedicated circuit.

The transmission/reception unit 2001 controls the communication unit 24 to transmit and receive various kinds of information to and from the server device 3. For example, the transmission/reception unit 2001 controls the communication unit 24 to transmit the event information registered in the schedule management file 213 to the server device 3. Further, the transmission/reception unit 2001 controls the communication unit 24 to receive the commodity information from the server device 3. In other words, the transmission/reception unit 2001 functions as a transmission unit that controls the communication unit 24 to transmit event information to the server device 3, and also functions as a reception unit that controls the communication unit 24 to receive commodity information from the server device 3.

Various types of information are input to the input unit 2002 from the operating unit 23. For example, a code for specifying an event is input from the operating unit 23 to the input unit 2002. In addition, information indicating the scheduled event date is input from the operating unit 23 to the input unit 2002.

The registration unit 2003 registers information related to the event input to the input unit 2002 in the schedule management file 213. Specifically, the registration unit 2003 reads the event corresponding to the code of the event input to the input unit 2002 from the event file 212 and registers the event in the schedule management file 213. Further, the registration unit 2003 registers, in the schedule management file 213, information indicating the date input in association with the code in the input unit 2002.

The display control unit 2004 causes the display unit 22 to display various types of information. For example, the display control unit 2004 causes the display unit 22 to display an operation screen for the user to input an event code or an event scheduled date to the input unit 2002. Further, the display control unit 2004 causes the display unit 22 to display the commodity information received from the server device 3 by the transmission/reception unit 2001.

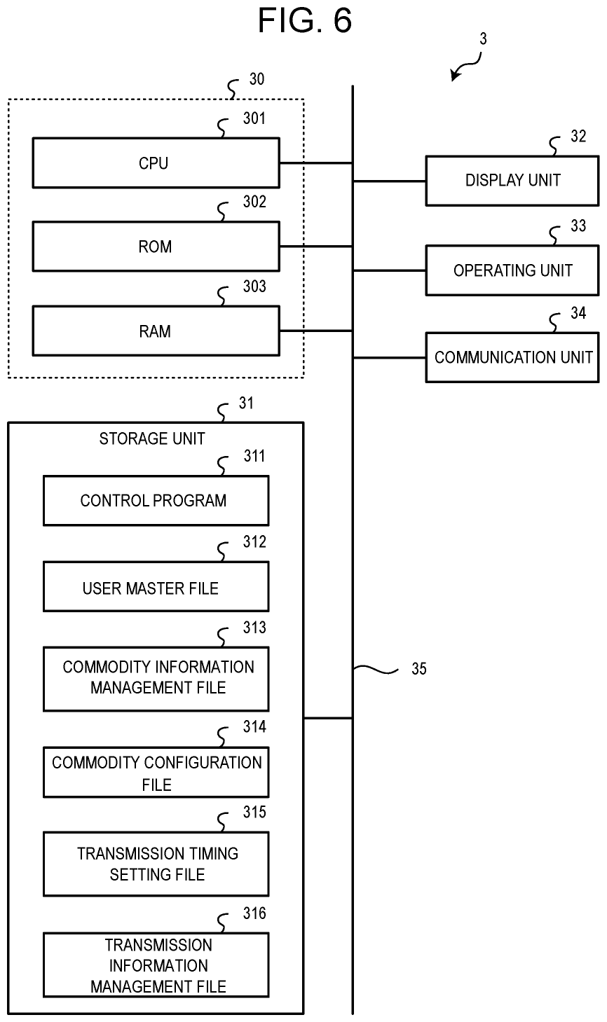

Next, the server device 3 will be described in detail. FIG. 6 is a hardware block diagram of the server device 3. The server device 3 includes a control unit 30, a storage unit 31, a display unit 32, an operating unit 33, and a communication unit 34. The control unit 30, the storage unit 31, the display unit 32, the operating unit 33, and the communication unit 34 are connected to each other via a bus 35 or the like.

The control unit 30 is a controller including a CPU 301, a ROM 302, RAM 303. The CPU 301, the ROM 302 and the RAM 303 are connected to each other via the bus 35.

The CPU 301 controls the entire operation of the server device 3. The ROM 302 stores various programs such as programs executed by the CPU 301 and various types of data. The RAM 303 is used as a work area of the CPU 301 and temporarily stores various programs and various data loaded from the ROM 302 and the storage unit 31. The control unit 30 or the CPU 301 executes various control processes of the server device 3 in accordance with the control program stored in the ROM 302 or the storage unit 31 and loaded onto the RAM 303.

The storage unit 31 is constituted by a storage medium such as an HDD or a flash memory, and maintains the stored data even if the power supply is cut off. The storage unit 31 stores a control program 311, a user master file 312, a commodity information management file 313, a commodity setting file 314, a transmission timing setting file 315, and a transmission information management file 316.

The control program 311 realizes a function of managing user information acquired from a user, a function of managing commodity information acquired from each store S, a function of acquiring event information from the user terminal 2, a function of determining commodity information related to the acquired event information from the commodity information management file 313, a function of transmitting the commodity information to the user terminal 2, and the like.

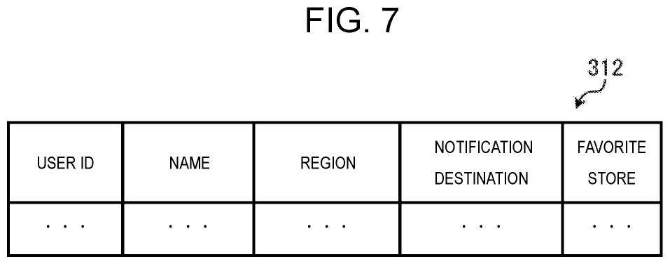

The user master file 312 is a master file that stores user information. The user master file 312 acquires information from a user when the user applies for use of the commodity information providing system 1. It is assumed that the user approves that the event information registered in the user terminal 2 as a schedule is transmitted to the server device 3 by applying for use of the commodity information providing system 1. FIG. 7 depicts a data structure of the user master file 312. The user master file 312 stores a name, a region, a notification destination, and a favorite store in association with the user ID.

The user ID is unique information set for each user for specifying the user. The name is information indicating the name of the user. The region is information indicating a region including stores S from which the user wants to receive commodity information. For example, the user can acquire commodity information from the store S close to the home by registering the area where the home is located, and can acquire the commodity information from the store S close to the work place by registering the area where the work place is located.

The notification destination is, for example, an email address of the user using the user terminal 2. The favorite store is information indicating the user's favorite store S from which the user wants to receive commodity information, and is, for example, a store ID of the store S. The favorite store does not necessarily have to be registered. When the favorite store is registered, the user can receive commodity information from the favorite store regardless of the region of the store S.

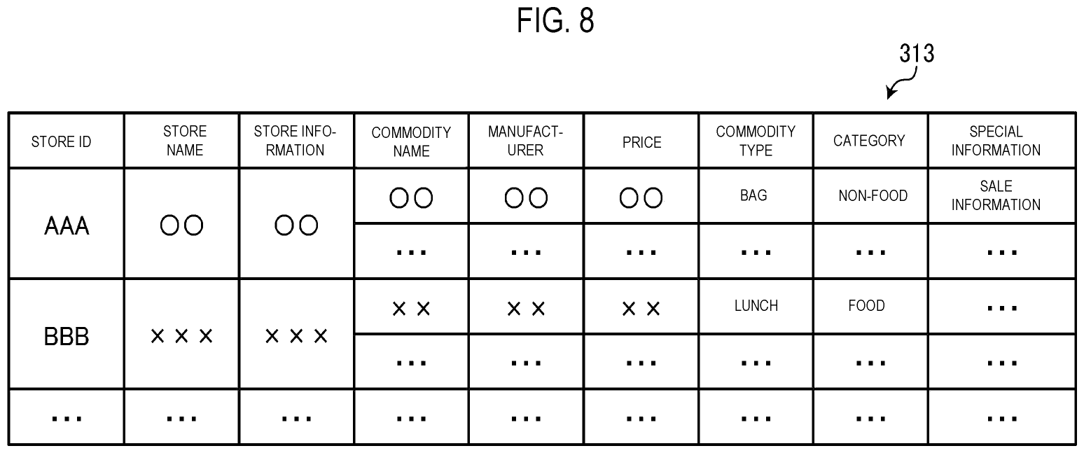

The commodity information management file 313 is a file for managing the commodity information acquired from each store S. The commodity information management file 313 is updated every time the commodity information is acquired from each store S. FIG. 8 depicts a data structure of the commodity information management file 313. The commodity information management file 313 stores the store ID in association with the store name, the store information, and one or more sets of the commodity name of a commodity sold by the store and the manufacturer, the price, the commodity type, the category, and the special information of the commodity ID. That is, the commodity information management file 313 stores commodity information of each commodity sold by the store S.

The store ID is information for specifying the store S. The store name is information indicating the name of the store S. The store information indicates the location or address of the store S, map data, business hours, fixed holidays, and the like. The location is associated with a region registered in the user master file 312. In other words, the server device 3 can determine the area of the store S according to the location of the store S.

The commodity name is information indicating the name of the commodity sold at the store S. The manufacturer is information indicating the manufacturer of the commodity. When the store S provides services, the information of the manufacturer is not registered. The price is information indicating the price of the commodity. The commodity type is information indicating the type of the commodity. The category is information indicating a category of the commodity, specifically, whether the commodity is a food commodity or a non-food commodity. The special information is information that the store S wants to notify the user, and is, for example, sale information indicating the description of the sale.

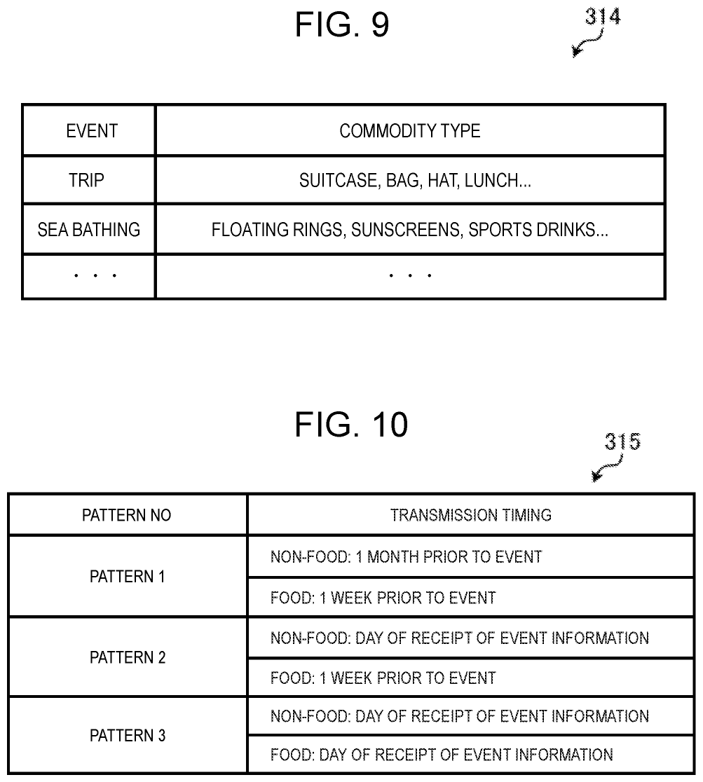

In the commodity setting file 314, a commodity type related to an event is set in advance. The commodity setting file 314 may be set by an operator who operates the commodity information providing system 1. FIG. 9 depicts a data structure of the commodity setting file 314. The commodity setting file 314 stores the events and the commodity types in association with each other.

The event is information indicating the description of the event received from the user terminal 2. The commodity type is information indicating the type of the commodity as described above. Note that the commodity setting file 314 is not necessarily required. For example, when the server device 3 sets the commodity type corresponding to the event by machine learning, the commodity setting file 314 may not be stored. Machine learning is a known technique that learns a pattern using a large amount of learning data, and estimates unknown data using a learning result. In the above case, the learning model that performs machine learning estimates the commodity type related to the event on the basis of the information indicating the input event.

Further, when the server device 3 searches for a commodity type related to an event from an external social media, the commodity setting file 314 may not be stored. In this case, for example, when the description of the event is “trip”, the server device 3 searches the social media using the keyword as “trip”. Since the search result includes words other than the commodity type, the server device 3 narrows down the commodity type from the search result. As a method of narrowing down the search result to the commodity type, any method such as a method of using machine learning or a method of narrowing down the search result to the commodity type registered in the commodity information management file 313 can be adopted.

The transmission timing setting file 315 sets a timing at which the commodity information is transmitted to the user terminal 2 in accordance with a timing at which the server device 3 receives the event information. The transmission timing setting file 315 may be set by the operator who operates the commodity information providing system 1. FIG. 10 depicts a data structure of the transmission timing setting file 315. The transmission timing setting file 315 stores the pattern numbers (Nos) and the transmission timing in association with each other.

The pattern No is information for specifying a transmission pattern. The transmission timing is information indicating a transmission timing set for each category of the commodity. In the present embodiment, when, for example, the transmission pattern 1 is set upon receipt of event information by the server device 3, commodity information of a non-food commodity corresponding to the event information is transmitted one month prior to the event. Further, commodity information of a food commodity is transmitted one week prior to the event.

Similarly, when the transmission pattern 2 is set, commodity information of a non-grocery commodity corresponding to the event information is transmitted on the day when the event information is received, and commodity information of a food commodity is transmitted one week prior to the event. When the transmission pattern 3 is set, commodity information of a non-food commodity corresponding to the event information and commodity information of a food commodity are transmitted on the day when the event information is received.

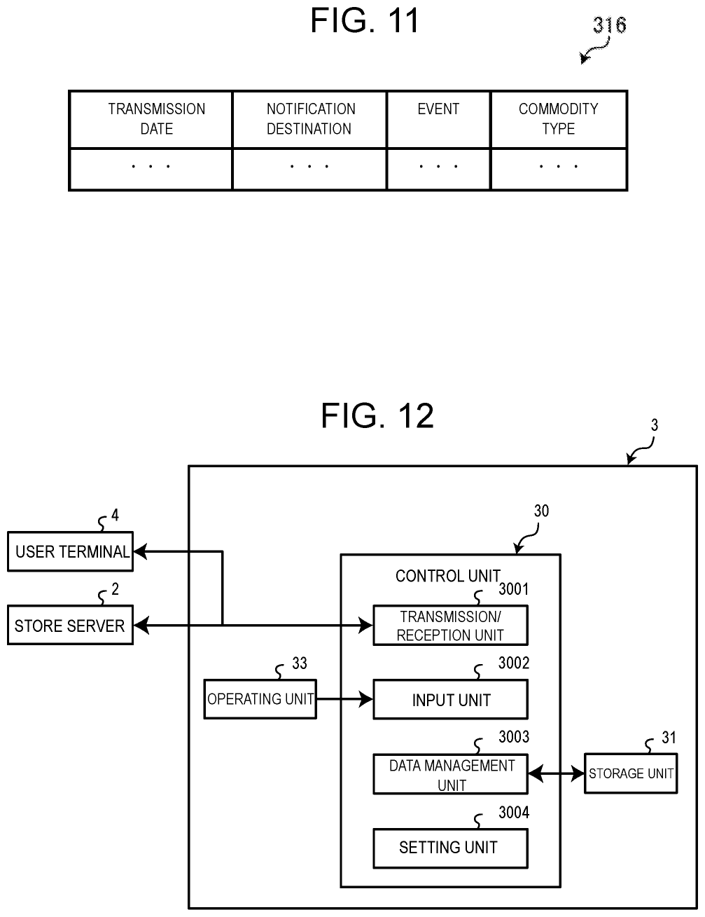

The transmission information management file 316 manages transmission information to be transmitted to the user terminal 2. The server device 3 selects a commodity type corresponding to the event information received from the user terminal 2 from the commodity setting file 314, and sets a timing at which the selected commodity type is transmitted, and then registers the information in the transmission information management file 316. FIG. 11 depicts a data structure of the transmission information management file 316. The transmission information management file 316 stores a notification destination, an event, and a commodity type in association with a transmission date.

The transmission date indicates a date when the commodity type is transmitted. The notification destination is, for example, an email address of the user using the user terminal 2 serving as the transmission destination. As described above, the event is information indicating the description of the event received from the user terminal 2, and the commodity type is information indicating the type of the commodity.

Returning to FIG. 6, the hardware configuration of the server device 3 will be described.

The display unit 32 includes, for example, a liquid crystal panel, and displays various types of information. The display unit 32 displays, for example, information stored in the user master file 312, the commodity information management file 313, the commodity setting file 314, the transmission timing setting file 315, and the transmission information management file 316 as needed.

The operating unit 33 receives an input of information, and includes a keyboard, a touch panel, a mouse, and the like.

The communication unit 34 is a communication interface circuit for communicating with an external device such as the user terminal 2 and the store server 4. The control unit 30 can transmit and receive information or data to and from an external device by being connected to the external device via the communication unit 34.

Next, a functional configuration of the control unit 30 of the server device 3 will be described. FIG. 12 is a functional block diagram of the control unit 30 of the server device 3. The control unit 30 functions as a transmission/reception unit 3001, an input unit 3002, a data management unit 3003, and a setting unit 3004 when the CPU 301 executes the control program stored in the ROM 302 or the storage unit 31. One or more of these functions may be performed by hardware such as a dedicated circuit.

The transmission/reception unit 3001 controls the communication unit 34 to transmit and receive various kinds of information to and from the user terminal 2 and the store server 4. For example, the transmission/reception unit 3001 controls the communication unit 34 to receive event information registered in the user terminal 2 from the user terminal 2. The transmission/reception unit 3001 functions as an acquisition unit to acquire event information indicating an event registered in the user terminal 2. Then, the transmission/reception unit 3001 controls the communication unit 34 to transmit the commodity information corresponding to the received event information, for example, the commodity type, to the user terminal 2 that is the transmission source of the event information. The transmission/reception unit 3001 controls the communication unit 34 to transmit the commodity type on the transmission date set by the setting unit 3004. The transmission/reception unit 3001 functions as an output unit to output the commodity information to the user terminal 2 in which an event related to the commodity information is registered.

The transmission/reception unit 3001 controls the communication unit 34 to receive, from the user terminal 2, a commodity information request for a commodity corresponding to the commodity type selected by the user from among the commodity types transmitted to the user terminal 2. Then, the transmission/reception unit 3001 controls the communication unit 34 to transmit the commodity information read from the commodity information management file 313 by the data management unit 3003 to the user terminal 2 that is the transmission source of the commodity information request. The commodity information transmitted in response to the commodity information request is information including a commodity name, a price range, a manufacturer, and the like of the commodity corresponding to the selected commodity type.

The transmission/reception unit 3001 controls the communication unit 34 to receive, from the user terminal 2, a detailed commodity information request of a commodity selected by the user from the commodity information transmitted to the user terminal 2. Then, the transmission/reception unit 3001 controls the communication unit 34 to transmit the detailed commodity information read from the commodity information management file 313 by the data management unit 3003 to the user terminal 2 that is the transmission source of the detailed commodity information request. The detailed commodity information transmitted in response to the detailed commodity information request is information including one or more stores S that sell the commodity selected by the user, a price thereof at each store S, and the like.

The transmission/reception unit 3001 controls the communication unit 34 to receive, from the user terminal 2, a store information request of the store S selected by the user from the detailed commodity information transmitted to the user terminal 2. Then, the transmission/reception unit 3001 controls the communication unit 34 to transmit the store information read from the commodity information management file 313 by the data management unit 3003 to the user terminal 2 that is the transmission source of the store information request. The store information transmitted in response to the store information request is information including the location and map information of the store S selected by the user. The commodity type, the commodity name, the price of the commodity, the manufacturer of the commodity, the store information of the store S that sells the commodity, and the like are transmitted to the user terminal 2 as commodity information by the transmission/reception unit 3001.

The transmission/reception unit 3001 controls the communication unit 34 to receive, from the store server 4 of each store S, the commodity information, the store information, and the like of the commodities sold by the stores S. In addition, the transmission/reception unit 3001 controls the communication unit 34 to receive user information from the user terminal 2.

Various types of information are input to the input unit 3002 through the operating unit 33. For example, various kinds of information to be registered in the commodity setting file 314 and the transmission timing setting file 315 are input to the input unit 3002.

The data management unit 3003 manages information stored in the storage unit 31. Here, managing information means storing information in the storage unit 31 or reading information from the storage unit 31 as necessary.

When the event information is received from the user terminal 2 via the transmission/reception unit 3001, the data management unit 3003 reads the commodity type corresponding to the event included in the event information from the commodity setting file 314. Further, when a commodity information request, a detailed commodity information request, a store information request, and the like are received from the user terminal 2 via the transmission/reception unit 3001, the data management unit 3003 reads necessary information from the commodity information management file 313. The data management unit 3003 functions as an acquisition unit that acquires the commodity information of the commodity related to the event information acquired by transmission/reception unit 3001 from the commodity information management file 313 that stores the commodity information of the commodity sold by the store S.

When the date of transmission of the commodity information is set by the setting unit 3004, the data management unit 3003 stores the transmission information in the transmission information management file 316. In the present embodiment, the transmission/reception unit 3001 is configured to control the communication unit 34 to first transmit the commodity type to the user terminal 2, and then sequentially receive the commodity information request, the detailed commodity information request, and the store information request. For this reason, the transmission information management file 316 stores the commodity type which is the information first transmitted by the transmission/reception unit 3001 to the user terminal 2, but is not limited thereto. When the transmission/reception unit 3001 controls the communication unit 34 to first transmit various kinds of information such as commodity information, commodity detail information, and store information to the user terminal 2, the transmission information management file 316 may store these various kinds of information in place of or in addition to the commodity type.

The setting unit 3004 sets a timing at which the transmission/reception unit 3001 outputs the commodity information acquired by the data management unit 3003. Specifically, the setting unit 3004 sets a timing at which the commodity information is output in accordance with a timing at which the event information is received via the transmission/reception unit 3001.

Specifically, the setting unit 3004 sets the transmission timing of the transmission pattern 1 illustrated in FIG. 10 when the scheduled event date included in the event information received by the transmission/reception unit 3001 is one month or more after the reception date of the event information. Further, when the scheduled event date is one week or more and less than one month after the reception date of the event information, the setting unit 3004 sets the transmission timing of the transmission pattern 2 illustrated in FIG. 10. Furthermore, when the scheduled event date is less than one week from the reception date of the event information, the setting unit 3004 sets the transmission timing of the transmission pattern 3 illustrated in FIG. 10.

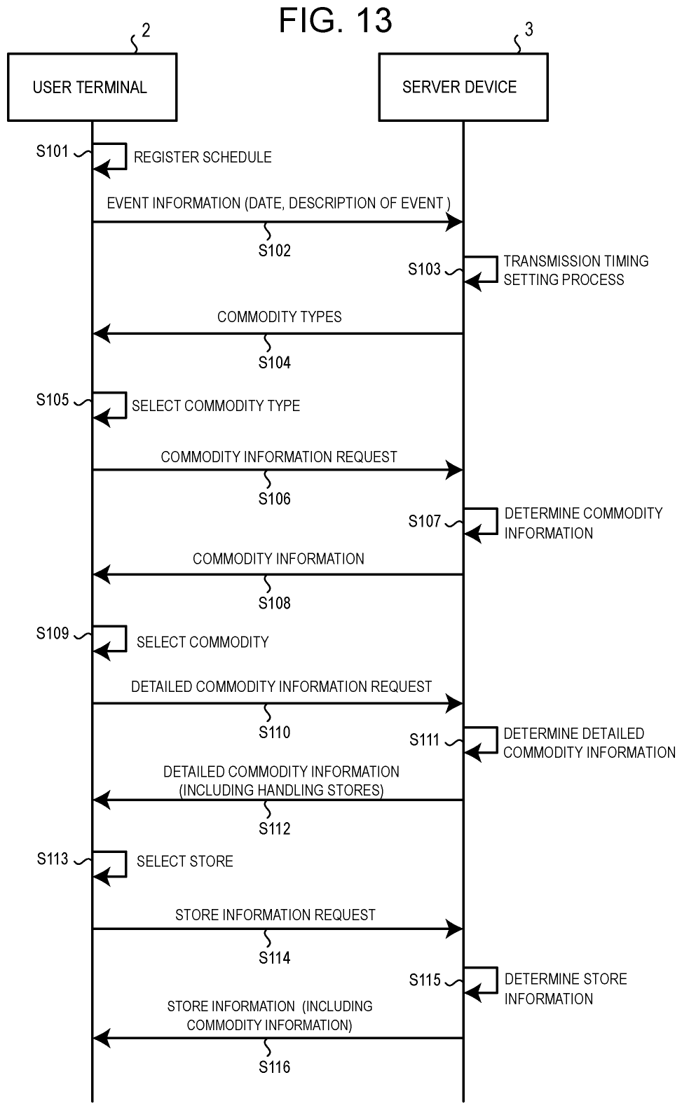

Next, the operation of the commodity information providing system 1 having the above-described configuration will be described. FIG. 13 is a sequence chart of the operation of the commodity information providing system 1.

When the user inputs a schedule to the user terminal 2 in order to manage his/her schedule, the user terminal 2 registers the input schedule (step S101). The user terminal 2 transmits event information including the description of the event registered as the schedule and the scheduled event date to the server device 3 (step S102).

The server device 3 executes a transmission timing setting process based on the received event-information (step S103). The server device 3 determines commodity types related to the description of the event received from the user terminal 2 by the transmission timing setting process, and sets a timing at which the determined commodity types are transmitted to the user terminal 2. Details of the transmission timing setting process will be described later.

The server device 3 transmits the commodity types to the user terminal 2 at the timing set in the transmission timing setting process (step S104). The commodity types to be transmitted are the commodity types that have been determined in the transmission timing setting process. The user terminal 2 displays the received commodity types. When the user selects one of the displayed commodity types, the user terminal 2 receives the commodity type selection (step S105). The user terminal 2 transmits a commodity information request to the server device 3 for the commodity of the selected commodity type (step S106). For example, when the selected commodity type is “suitcase”, the commodity information of the suitcase sold at each store S is requested.

The server device 3 determines commodity information in response to the commodity information request (step S107). The server device 3 transmits the determined commodity information to the user terminal 2 (step S108). For example, the server device 3 transmits, to the user terminal 2, commodity information including a manufacturer name, a commodity name, a price range, and the like for a plurality of commodities whose commodity types are “suitcase”. The user terminal 2 displays the received commodity information. When the user selects one of the displayed commodity information, the commodity selection is inputted to the user terminal 2 (step S109). The user terminal 2 transmits a detailed commodity information request to the server device 3 for the selected commodity (step S110).

The server device 3 determines detailed commodity information in response to the detailed commodity information request (step S111). The server device 3 transmits the determined detailed commodity information to the user terminal 2 (step S112). For example, the server device 3 transmits, to the user terminal 2, detailed commodity information including, for the commodity selected by the user, a store that sells the commodity, a sales price at the store, sales information of the commodity at the store, and the like. The user terminal 2 displays the received detailed commodity information. When the user selects one of the displayed detailed commodity data, the user terminal 2 receives a store selection (step S113). The user terminal 2 transmits a store information request requesting information of the selected store to the server device 3 (step S114).

The server device 3 determines store information in response to the store information request (step S115). The server device 3 transmits the determined store information to the user terminal 2 (step S116). For example, the server device 3 transmits store information including a store name, a location, business hours, a fixed holiday, and the like to the user terminal 2 with respect to the store selected by the user.

The user terminal 2 displays various kinds of information received from the server device 3, and thus can inform the user of the commodity related to the event information registered by the user. This allows the user to recognize a commodity associated with the event, e.g., which may be necessary for the event, and to prepare the commodity by the scheduled event date. Further, since the commodity information is provided to the user at a timing when the user is considered to need the commodity, the store S selling the commodity can be expected to improve the sales.

In the sequence chart of FIG. 13, among the processes related to the step S104 to the step S116, process executed by the server device 3 is referred to as commodity information transmitting process. Details of the commodity information transmission process will be described later.

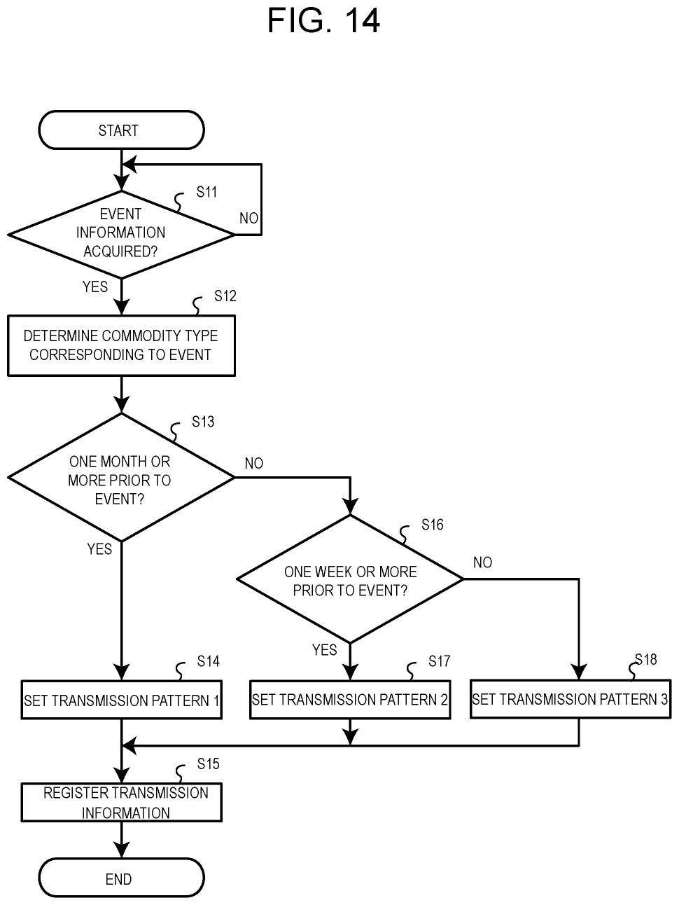

Next, a transmission timing setting process executed by the server device 3 will be described. FIG. 14 is a flowchart of the transmission timing setting process performed by the control unit 30 of the server device 3.

The control unit 30 determines whether the transmission/reception unit 3001 has acquired the event information (step S11), and if not (No in step S11), returns to the process of step S11 and waits. The control unit 30 executes the process of the step S11 by determining whether the transmission/reception unit 3001 has received event information from any one of the user terminals 2.

When the event information is received from the user terminal 2 (Yes in step S11), the data management unit 3003 determines the commodity type corresponding to the event (step S12). Specifically, the data management unit 3003 reads the commodity type corresponding to the event indicated by the event information from the commodity setting file 314.

Next, the setting unit 3004 determines whether the date on which the event information is received is one month or more prior to the scheduled event date included in the event information (step S13). In other words, the setting unit 3004 determines whether the scheduled event date is one month or more ahead of the date on which the event is registered by the user.

When the date on which the event information is received is one month or more prior to the scheduled event date included in the event information (Yes in step S13), the setting unit 3004 sets the transmission pattern 1 as the transmission timing (step S14).

Subsequently, the data management unit 3003 registers the transmission information in the transmission information management file 316 (step S15). Specifically, the data management unit 3003 registers, in the transmission information management file 316, transmission information in which the transmission date, the notification destination, the event, and the commodity type are associated with each other. The transmission date is the transmission timing by the transmission pattern 1 set in the process of the step S14. The notification destination is registered in the user master file 312 in response to the user ID transmitted from the user terminal 2 together with the event information. The event is indicated by the event information. The commodity type is read from the commodity setting file 314 in the process of the step S12. Then, the control unit 30 ends the transmission timing setting process.

In the process of step S13, if the date on which the event information is received is not one month or more prior to the scheduled event date included in the event information (No in step S13), the setting unit 3004 determines whether that date is one week or more prior to the scheduled event date included in the event information (step S16). In other words, the setting unit 3004 determines whether the scheduled event date is within one month and one week or longer from the date when the event is registered by the user.

When the date on which the event information is received is one week or more prior to the scheduled event date included in the event information (Yes in step S16), the setting unit 3004 sets the transmission pattern 2 as the transmission timing (step S17). Then, the control unit 30 proceeds to the process of the step S15.

When the date on which the event information is received is not one week or more prior to the scheduled event date included in the event information (No in step S16), the setting unit 3004 sets the transmission pattern 3 as the transmission timing (step S18). Then, the control unit 30 proceeds to the process of the step S15.

By the above-described transmission timing setting process, it is possible to set a transmission timing suitable for the commodity information to be transmitted to the user terminal 2.

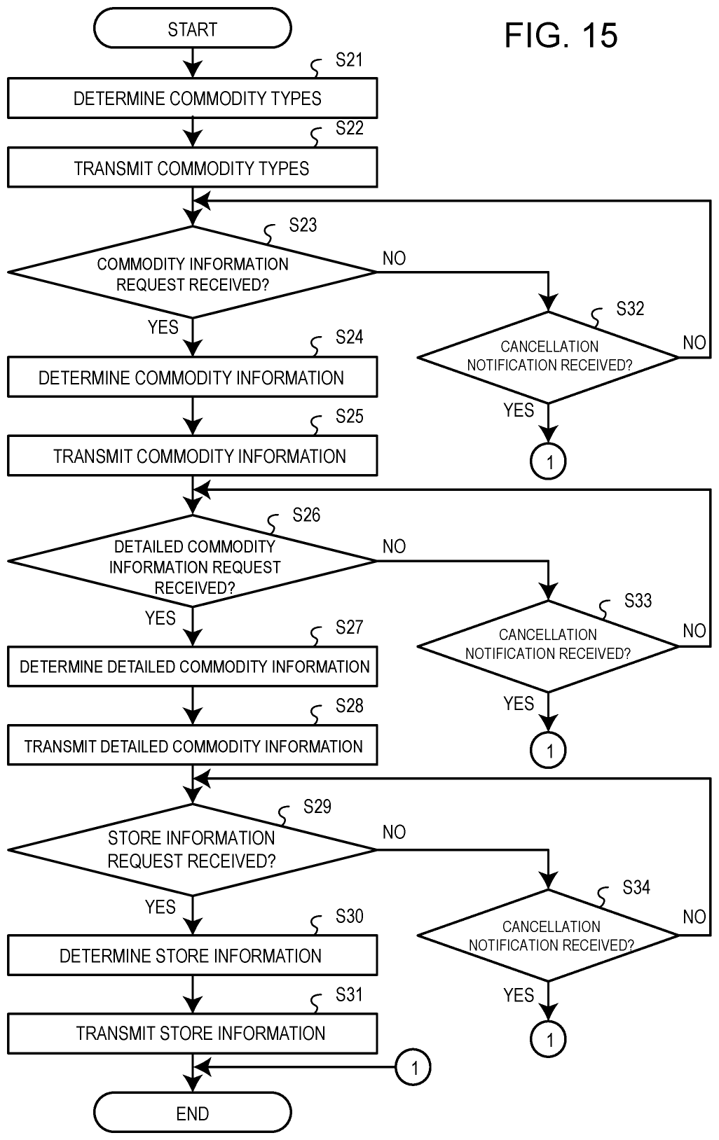

Next, a commodity information transmission process executed by the server device 3 will be described. The commodity information transmission process is executed periodically, for example, at a predetermined time every day. FIG. 15 is a flowchart of the commodity information transmission process performed by the control unit 30 of the server device 3.

The data management unit 3003 determines the commodity types that now is the transmission timing (i.e., today is the transmission date) (step S21). Next, the transmission/reception unit 3001 controls the communication unit 34 to transmit the commodity types to the corresponding user terminal 2 (step S22). Specifically, the data management unit 3003 reads information (a commodity type, a notification destination, and an event) whose transmission date is today from the transmission information management file 316. Then, the transmission/reception unit 3001 controls the communication unit 34 to transmit the event and the commodity types to the notification destination read by the data management unit 3003 as a destination.

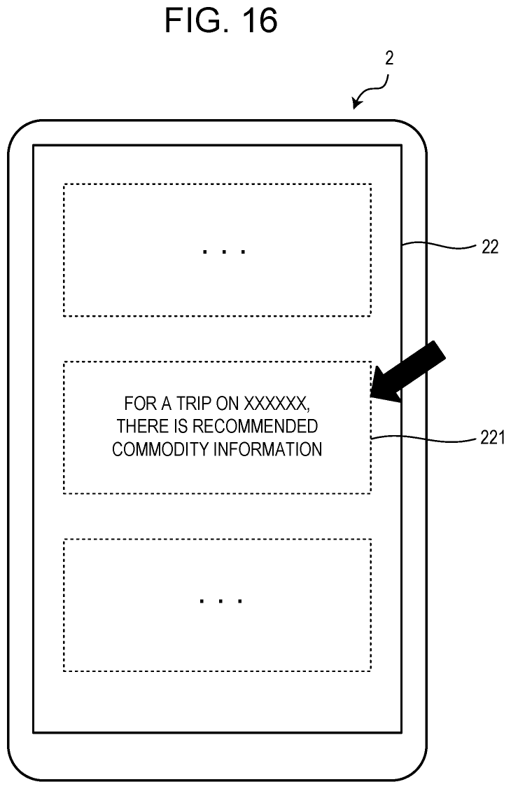

At this time, a first display screen shown in FIG. 16 is displayed on the display unit 22 of the user terminal 2 by t the application program for the commodity information providing system 1. The first display screen includes a notification display area 221. The notification display area 221 displays a message including an event scheduled date, a description of the event, and recommended commodity information. For example, the notification display area 221 displays a message such as “For a trip on xxxxxx, there is recommended commodity information.”

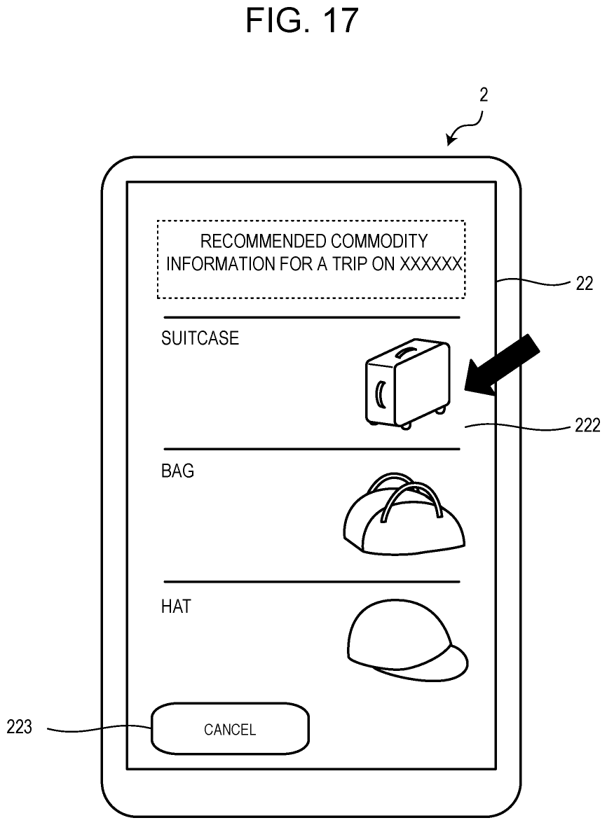

When the user taps the notification display area 221, the display of the display unit 22 is switched to a second display screen shown in FIG. 17. On the second display unit screen, a plurality of commodity type display areas 222 and a cancel button 223 are displayed. In the example of FIG. 17, “suitcase”, “bag”, and “hat”, which are three commodity types transmitted from the server device 3, are displayed on the commodity type display unit 222. The cancel button 223 is for canceling the display of the commodity information.

Returning to FIG. 15, the control unit 30 determines whether a commodity information request has been received from the user terminal 2 (step S23). The commodity information request is transmitted from the user terminal 2 to the server device 3 by the user tapping any one of the commodity type display areas 222 to select a commodity type on the second display screen of FIG. 17. At this time, the user can select two or more commodity types. The commodity information request indicates one or more commodity types selected by the user.

When the commodity information request has been received (Yes in step S23), the data management unit 3003 determines the commodity information corresponding to the commodity type included in the commodity information request from the commodity information management file 313 (step S24). Here, the commodity information is, for example, a commodity name, a manufacturer, a price, or the like. The transmission/reception unit 3001 controls the communication unit 34 to transmit the commodity information to the user terminal 2 that is the source of the commodity information request (step S25).

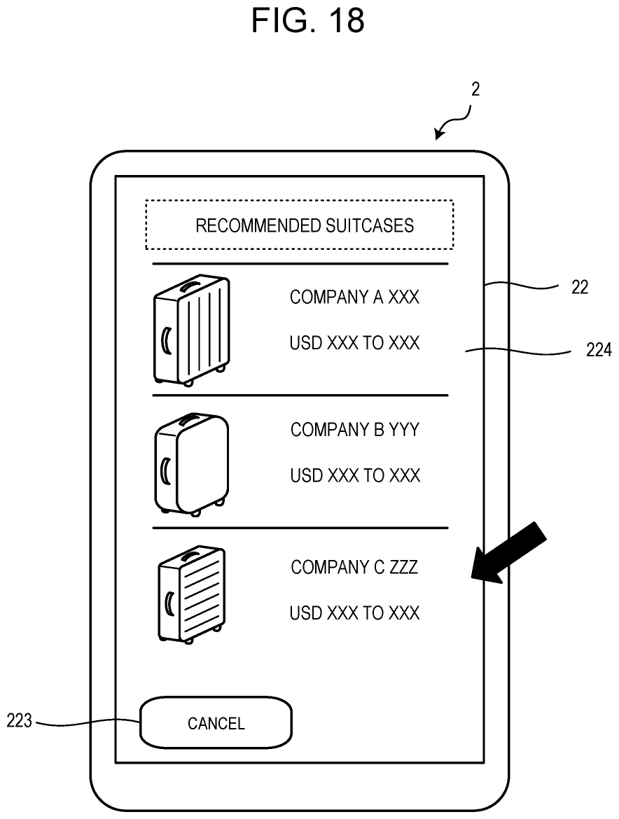

At this time, a third display screen shown in FIG. 18 is displayed on the display unit 22 of the user terminal 2. On the third display screen, a plurality of commodity information display areas 224 and a cancel button 223 are displayed. In the example of FIG. 18, the commodity type display area 222 of the “suitcase” has been tapped on the second display screen of FIG. 17. The commodity information display area 224 displays the commodity information received from the server device 3 for each commodity name.

Returning to FIG. 15, the control unit 30 determines whether a detailed commodity information request has been received from the user terminal 2 (step S26). The detailed commodity information request is transmitted from the user terminal 2 to the server device 3 by the user tapping any one of the commodity information display areas 224 to select a commodity on the third display screen of FIG. 18. At this time, the user can select two or more commodities. The detailed commodity information request includes one or more commodity names selected by the user.

When the detailed commodity information request has been received (Yes in step S26), the data management unit 3003 determines the detailed commodity information corresponding to the commodity name included in the detailed commodity information request from the commodity information management file 313 (step S27). At this time, the data management unit 3003 narrows down the detailed commodity information to be determined based on the region information of the user master file 312 and the location of the store information in the commodity information management file 313. In other words, the data management unit 3003 determines the information of the store S corresponding to the area of the user master file 312 from the detailed commodity information corresponding to the commodity name included in the detailed commodity information request in the commodity information management file 313. The data management unit 3003 also determines information of the store S corresponding to the favorite store of the user master file 312 from the detailed commodity information corresponding to the commodity name included in the detailed commodity information request in the commodity information management file 313.

Here, the determined detailed commodity information indicates, for example, a store name, a price, and special information for selling the commodity. In addition, when the store name of the favorite store of the user is included in the store name to be transmitted as the detailed commodity information, the server device 3 transmits the store name and the information indicating that the store is the favorite store to the user terminal 2 in association with each other. The transmission/reception unit 3001 controls the communication unit 34 to transmit the extracted detailed commodity information to the user terminal 2 that is the source of the detailed commodity information request (step S28).

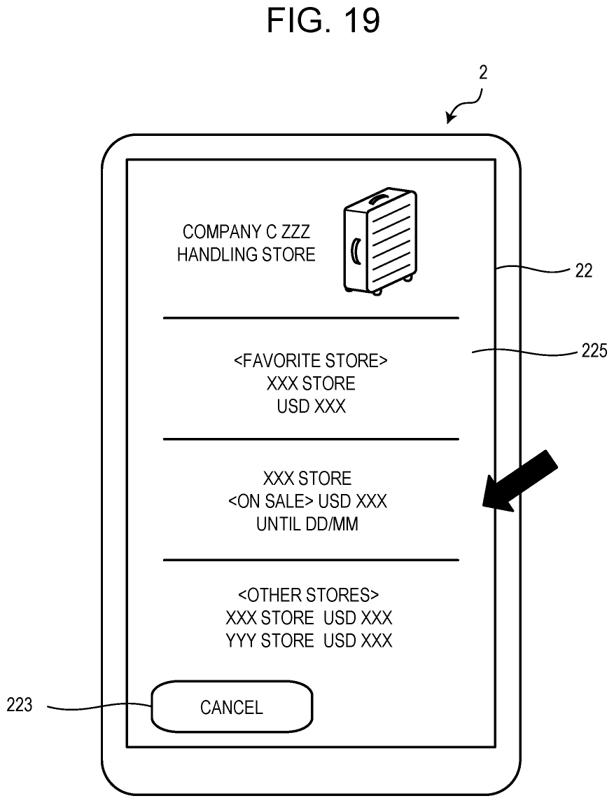

At this time, a fourth display screen illustrated in FIG. 19 is displayed on the display unit 22 of the user terminal 2. On the fourth display screen, a plurality of detailed commodity information display areas 225 and a cancel button 223 are displayed. In the example of FIG. 19, the commodity information display area 224 of “Company C ZZZ” has been tapped on the third display screen of FIG. 18. The detailed commodity information display area 225 displays the detailed commodity information received from the server device 3 for each store name. In addition, when the user terminal 2 receives a store name associated with information indicating that the store is the user's favorite store from the server device 3, the user terminal 2 displays the detailed commodity information related to the store name at the top of the detailed commodity information display areas 225. In other words, the user terminal 2 can preferentially display the information of the favorite store of the user.

Returning to FIG. 15, the control unit 30 determines whether a store information request has been received from the user terminal 2 (step S29). The store information request is transmitted from the user terminal 2 to the server device 3 by the user tapping any of the detailed commodity information display areas 225 to select a store on the fourth screen of FIG. 19. At this time, the user can select two or more stores. The store information request includes one or more store names selected by the user.

When the store information request has been received (Yes in step S29), the data management unit 3003 determines the store information corresponding to the store name included in the store information request from the commodity information management file 313 (step S30). The transmission/reception unit 3001 controls the communication unit 34 to transmit the determined store information to the user terminal 2 that is the source of the store information request (step S31). Then, the control unit 30 ends the commodity information transmission process.

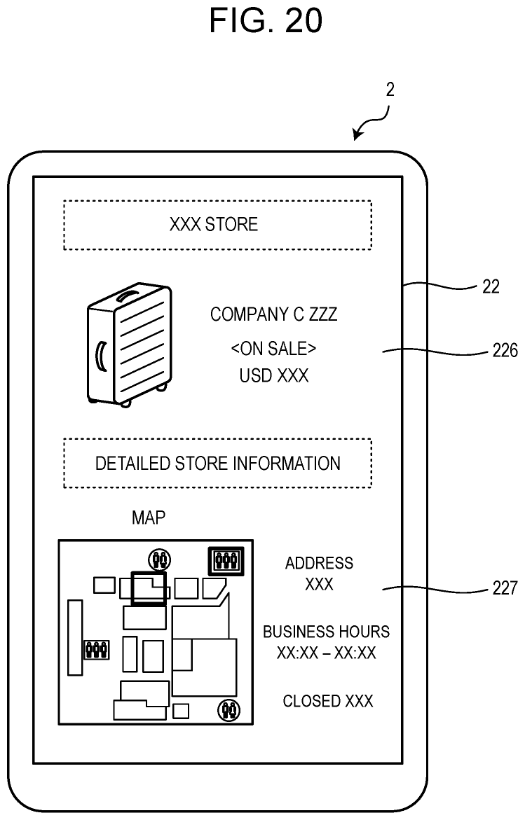

At this time, a fifth display screen shown in FIG. 20 is displayed on the display unit 22 of the user terminal 2. On the fifth display screen, a commodity display area 226 and a store information display area 227 are displayed. In the example of FIG. 20, the detailed commodity information display area 225 of “XXX store” has been tapped on the fourth display screen of FIG. 19. The commodity display area 226 displays commodity information of the store S selected by the user. The store information display area 227 displays the store information of the store S selected by the user. Specifically, the store information display area 227 displays the location of the store S, business hours, fixed holidays, and an access map.

In the process of step S23 shown in FIG. 15, when the commodity information request has not been received (No in step S23), the control unit 30 determines whether a cancellation notification has been received from the user terminal 2 (step S32). In other words, the control unit 30 determines whether the cancel button 223 has been tapped on the second display screen of FIG. 17.

When the cancellation notification has been received from the user terminal 2 (Yes in step S32), the control unit 30 ends the commodity-information transmitting process. When the cancellation notification has not been received from the user terminal 2 (No in step S32), the control unit 30 returns to the process of step S23.

In the process of step S26, if the detailed commodity information request has not been received (No in step S26), the control unit 30 determines whether a cancellation notification has been received from the user terminal 2 (step S33). In other words, the control unit 30 determines whether the cancel button 223 has been tapped on the third display screen of FIG. 18.

When the cancellation notification has been received from the user terminal 2 (Yes in step S33), the control unit 30 ends the commodity-information transmitting process. When the cancellation notification has not been received from the user terminal 2 (No in step S33), the control unit 30 returns to the process of step S26.

In the process of step S29, if the store information request has not been received (No in step S29), the control unit 30 determines whether a cancellation notification has been received from the user terminal 2 (step S34). In other words, the control unit 30 determines whether the cancel button 223 has been tapped on the fourth display screen of FIG. 19.

When the cancellation notification has been received from the user terminal 2 (Yes in step S34), the control unit 30 ends the commodity-information transmitting process. When the cancellation notification has not been received from the user terminal 2 (No in step S34), the control unit 30 returns to the process of step S29.

By the commodity information transmission process, the server device 3 can transmit the commodity information of the commodity related to the event registered in the user terminal 2 to the user terminal 2. This allows the user to prepare a commodity associated with the event. Further, the store S that sells the commodity can be expected to improve the sales of the commodity. In the above-described commodity information transmission process, the commodity information is provided to the user terminal 2 in stages, but the commodity information may be provided at one time. For example, when receiving the event information, the server device 3 may immediately transmit information for displaying the fifth display screen illustrated in FIG. 20 to the user terminal 2.

As described above, the server device 3 of the present embodiment includes the transmission/reception unit 3001 that acquires event information indicating an event registered in the user terminal 2 as a schedule of the user, the data management unit 3003 that determines the commodity information of the commodity related to the event information acquired by the transmission/reception unit 3001 from the commodity information management file 313 that stores the commodity information of the commodity sold by the store S, and the transmission/reception unit 3001 that outputs the commodity information determined by the data management unit 3003 to the user terminal 2 in which the event related to the commodity information is registered.

As a result, the server device 3 can contribute to the increase in sales of the store S that sells the commodity by utilizing the schedule of the user registered in the user terminal 2. Further, the server device 3 provides the user with the information of the commodity related to the event scheduled by the user, and also provides the store information, thereby prompting the user to visit the store and enhancing the effect of attracting consumers to the store. Therefore, the store can be expected to increase sales of commodities other than the commodities related to the event.

The server device 3 of the present embodiment further includes a setting unit 3004 that sets a timing at which the transmission/reception unit 3001 outputs the commodity information in accordance with the commodity information determined by the data management unit 3003.

As a result, the server device 3 can transmit the commodity information to the user terminal 2 at a timing deemed appropriate for the user. For example, the server device 3 can transmit the commodity information to the user terminal 2 at an early stage for a commodity that is considered to be prepared earlier than the scheduled event date, and at a later stage for a commodity that is considered to be prepared at a time closer to the scheduled event date.

Further, in the server device 3 of the present embodiment, the setting unit 3004 sets the timing at which commodity information of a food commodity is output later than the timing at which commodity information of a non-food commodity is output.

As a result, the server device 3 can prompt the user to prepare a commodity at an early stage for a non-food commodity that is desired to be prepared at an early stage, and can prompt the user to prepare a food commodity at a time close to the event, which is desired to be prepared at a time close to the event.

In addition, in the server device 3 of the present embodiment, the transmission/reception unit 3001 controls the communication unit 34 to transmit the commodity type as the commodity information, and transmit detailed information of the commodity belonging to the commodity type selected by the user among the commodity types.

As a result, the server device 3 enables the user terminal 2 to display the commodity information in stages. Therefore, the user can easily see the commodity information provided from the server device 3.

In the above-described embodiments, the control programs executed by the user terminal 2, the server device 3, and the store server 4 may be copied and installed from a non-transitory computer readable recording medium such as a CD-ROM. Further, the control program executed by each of the above-described devices may be stored in a computer connected to a network such as the Internet, and may be downloaded therefrom via the network.

While certain embodiments have been described, these embodiments have been presented by way of example only, and are not intended to limit the scope of the disclosure. Indeed, the novel embodiments described herein may be embodied in a variety of other forms; furthermore, various omissions, substitutions and changes in the form of the embodiments described herein may be made without departing from the spirit of the disclosure. The accompanying claims and their equivalents are intended to cover such forms or modifications as would fall within the scope and spirit of the disclosure.

What is claimed is:

1. An information management device for managing commodity information of commodities sold at stores, comprising:
a communication interface configured to communicate with a user terminal in which a scheduled event can be registered;
a memory that stores setting information in which one or more commodity types are associated with an event that can be registered by the user terminal and commodity information of commodities that are of the one or more commodity types; and
a processor configured to:
acquire event information indicating a first event registered by the user terminal via the communication interface,
based on the event information, search the memory for one or more of the commodity types associated with the first event,
acquire commodity information of each of the commodities of the one or more commodity types, and
control the communication interface to transmit the commodity information to the user terminal.

2. The information management device according to claim 1, wherein the processor is further configured to determine a transmission timing of the commodity information of each of the commodities depending on the commodity type thereof.

3. The information management device according to claim 2, wherein the transmission timing of commodity information of a food commodity is determined to be closer to a day of the first event than the transmission timing of commodity information of a non-food commodity.

4. The information management device according to claim 1, wherein the processor is configured to:
control the communication interface to transmit first information indicating one or more commodity types associated with the first event to the user terminal, and
upon receipt of second information indicating one or more of the commodity types indicated by the first information from the user terminal, acquire, as the commodity information to be transmitted to the user terminal, commodity information of each of commodities of the one or more of the commodity types indicated by the second information.

5. The information management device according to claim 4, wherein the first information causes the user terminal to display a first screen through which one or more of the commodity types indicated by the first information are selectable.

6. The information management device according to claim 1, wherein the transmitted commodity information causes the user terminal to display a second screen through which one or more of the commodities are selectable.

7. The information management device according to claim 6, wherein the processor is configured to:
upon selection of one or more of the commodities through the second screen, acquire detailed commodity information of each of the selected commodities, the detailed commodity information indicating one or more stores that sell a corresponding one of the selected commodities, and
control the communication interface to transmit the detailed commodity information to the user terminal.

8. The information management device according to claim 7, wherein the detailed commodity information causes the user terminal to display a third screen through which one of the stores is selectable.

9. The information management device according to claim 8, wherein the processor is configured to, upon selection of one of the stores through the third screen, acquire store information of the selected store and control the communication interface to transmit the store information to the user terminal.

10. The information management device according to claim 9, wherein the store information causes the user terminal to display a fourth screen indicating a name and a location of the selected store.

11. An information management system comprising:
a user terminal in which a scheduled event can be registered; and
a server device for managing commodity information of commodities sold at stores, including:
a communication interface configured to communicate with the user terminal,
a memory that stores setting information in which one or more commodity types are associated with an event that can be registered by the user terminal and commodity information of commodities that are of the one or more commodity types, and
a processor configured to:
acquire event information indicating a first event registered by the user terminal via the communication interface,
based on the event information, search the memory for one or more of the commodity types associated with the first event,
acquire commodity information of each of the commodities of the one or more commodity types, and
control the communication interface to transmit the commodity information to the user terminal.

12. The information management system according to claim 11, wherein the processor is further configured to determine a transmission timing of the commodity information of each of the commodities depending on the commodity type thereof.

13. The information management system according to claim 12, wherein the transmission timing of commodity information of a food commodity is determined to be closer to a day of the first event than the transmission timing of commodity information of a non-food commodity.

14. The information management system according to claim 11, wherein the processor is configured to:
control the communication interface to transmit first information indicating one or more commodity types associated with the first event to the user terminal, and
upon receipt of second information indicating one or more of the commodity types indicated by the first information from the user terminal, acquire, as the commodity information to be transmitted to the user terminal, commodity information of each of commodities of the one or more of the commodity types indicated by the second information.

15. The information management system according to claim 14, wherein the user terminal is configured to, upon receipt of the first information, display a first screen through which one or more of the commodity types indicated by the first information are selectable.

16. The information management system according to claim 11, wherein the user terminal is configured to, upon receipt of the commodity information, display a second screen through which one or more of the commodities are selectable.

17. The information management system according to claim 16, wherein the processor is configured to:
upon selection of one or more of the commodities through the second screen, acquire detailed commodity information of each of the selected commodities, the detailed commodity information indicating one or more stores that sell a corresponding one of the selected commodities, and
control the communication interface to transmit the detailed commodity information to the user terminal.

18. The information management system according to claim 17, wherein the user terminal is configured to, upon receipt of the detailed commodity information, display a third screen through which one of the stores is selectable.

19. The information management system according to claim 18, wherein the processor is configured to, upon selection of one of the stores through the third screen, acquire store information of the selected store and control the communication interface to transmit the store information to the user terminal.

20. A method carried out by an information management device for managing commodity information of commodities sold at stores, the method comprising:
storing in a memory setting information in which one or more commodity types are associated with an event that can be registered by the user terminal and commodity information of commodities that are of the one or more commodity types;
communicating with a user terminal in which a scheduled event can be registered, and acquiring event information indicating a first event registered by the user terminal;
based on the event information, searching the memory for one or more of the commodity types associated with the first event;
acquiring commodity information of each of the commodities of the one or more commodity types; and
transmitting the commodity information to the user terminal.
